(19) United States
(12) Patent Application Publication
(10) Pub. No.: US 2010/0125655 A1
(43) Pub. Date: May 20, 2010

(54) METHOD AND SYSTEM FOR CENTRALIZED LOGIC FOR CENTRALLY MANAGED MACHINES

(76) Inventor: Uri Elzur, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/619,221

(22) Filed: Nov. 16, 2009

Related U.S. Application Data
(60) Provisional application No. 61/116,166, filed on Nov. 19, 2008.

(51) Int. Cl. G06F 15/173

(52) U.S. Cl. 709/223

(57) ABSTRACT

Aspects of a method and system for centralized logic for centrally managed machines are provided. In this regard, a plurality of networking and/or computation units (NCUs) and a central management unit (CMU) may reside in a multi-unit networking system, and information may be communicated between the plurality of NCUs and the CMU such that a console connected to the CMU may be enabled to interface with the plurality of NCUs. At least some hardware that performs management functions, human interface functions, and/or graphics functions may be implemented only once in the multi-unit system and may be implemented on the CMU. Each of the plurality of NCUs and the CMU may be, for example, a blade server or a rack-mount server.

### CROSS-REFERENCE TO RELATED APPLICATIONS/INCORPORATION BY REFERENCE

This patent application makes reference to, claims priority to and claims benefit from U.S. Provisional Patent Application Ser. No. 61/116,166 filed on Nov. 19, 2008.

The above stated application is hereby incorporated herein by reference in its entirety.

### FIELD OF THE INVENTION

Certain embodiments of the invention relate to networking. More specifically, certain embodiments of the invention relate to a method and system for centralized logic for centrally managed machines.

### BACKGROUND OF THE INVENTION

As data centers continue to grow, and the cost of managing servers and clients grows, there is an even higher motivation to save cost. Although devices such as servers, for example, are not always attended by human beings, they still carry the overhead cost of their associated graphics processing, human interface, and/or management logic for each server. For example, a blade server may utilize an enclosure with up to 16 (or more) servers that shares one backplane, management and I/O switching. However, every server blade still has a complete graphics subsystem, human interface devices (HID), and management subsystem. Exemplary human interface devices may comprise USB or wireless HID devices, comprising keyboard, mouse and/or other pointing devices. This increases cost and complexity and consumes power additional power.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for centralized logic for centrally managed machines, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary centrally managed multi-unit networking system, in accordance with an embodiment of the invention.

FIG. 1B is a diagram illustrating an exemplary networking and/or computation unit (NCU) and corresponding central management unit (CMU), in accordance with an embodiment of the invention.

FIG. 1C is a diagram illustrating an exemplary NCU and corresponding central management unit (CMU), in accordance with an embodiment of the invention.

FIG. 2A is a flowchart illustrating exemplary steps for centralized management of one or more NCUs in a multi-unit networking system, in accordance with an embodiment of the invention.

FIG. 2B is a flowchart illustrating exemplary steps for centralized management of one or more NCUs, in accordance with an embodiment of the invention.

FIG. 3A is a diagram illustrating an exemplary chipset for centralized management of one or more NCUs, in accordance with an embodiment of the invention.

FIG. 3B is a diagram illustrating an exemplary chipset for centralized management of one or more NCUs, in accordance with an embodiment of the invention.

### DETAILED DESCRIPTION OF THE INVENTION

Certain embodiments of the invention may be found in a method and system for centralized logic for centrally managed machines. In various embodiments of the invention, a plurality of networking and/or computation units (NCUs) and a central management unit (CMU) may reside in a multi-unit networking system. Information may be communicated between the plurality of NCUs and the CMU such that a console connected to the CMU may be enabled to interface with the plurality of NCUs. At least some hardware that performs management functions, human interface functions, and/or graphics functions may be implemented only once in the multi-unit system and may be implemented on the CMU. The communicated information may comprise one or more of: graphics, data from one or more input devices, data to one or more output devices, data generated by one or more of the NCUs or by one or more of the sensors, and/or data that configures or controls operations of the NCU. Each of the plurality of NCUs and the CMU may be, for example, a blade server or a rack-mount server. The information may be packetized and communicated over a backplane of the multi-unit system, over copper cabling, and/or over fiber optic cabling. The backplane, copper cabling, and/or fiber optic cabling may carry the information in addition to network traffic communicated between the multi-unit system and devices external to the multi-unit system.

The CMU may be transparent to one or both of the console and an operating system of each of the plurality of NCUs. The console may be locally connected to the CMU and/or may be connected to the CMU via a network. The communicated information may comprise graphics and the CMU may render the graphics for display via the console. The CMU may be operable to output graphics to multiple displays simultaneously. User input may be received from the CMU and communicated to an operating system or hardware of the NCU, wherein the user input may originate in a console connected to the CMU. Data may be collected from one or more sensors on the NCU and communicated to the CMU. In response to the collected data, the CMU may generate data and communicate the generated data to the NCU.

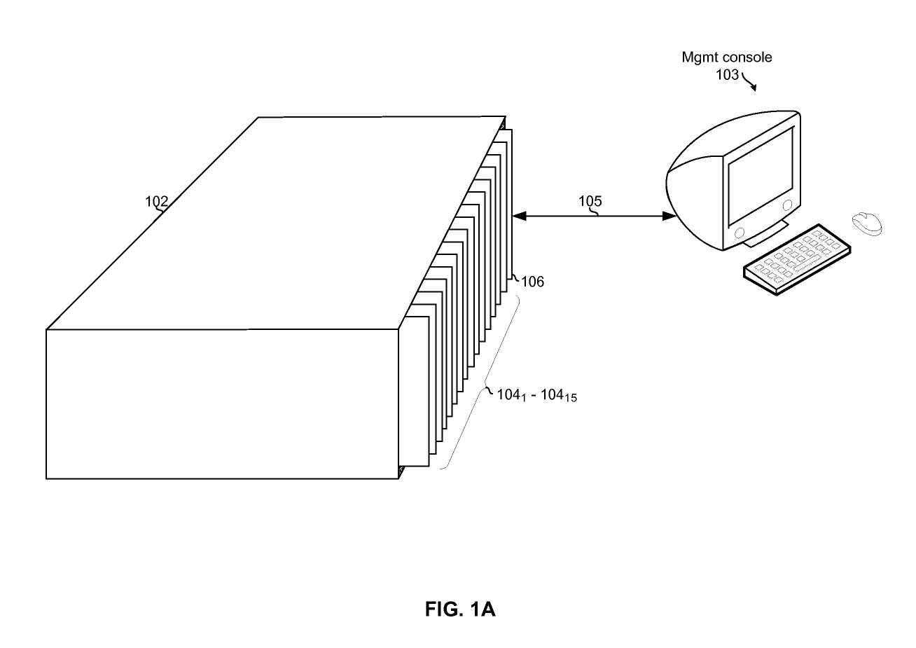

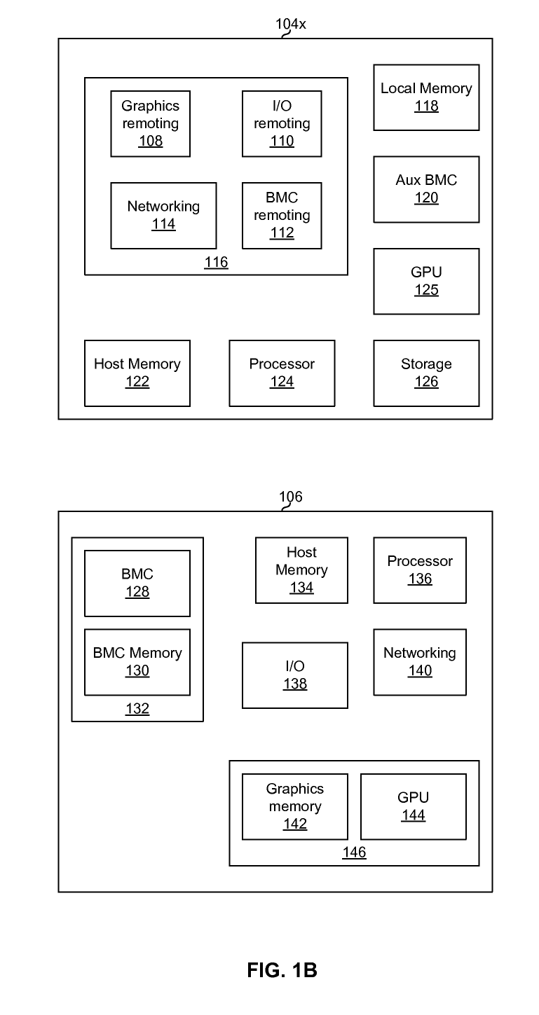

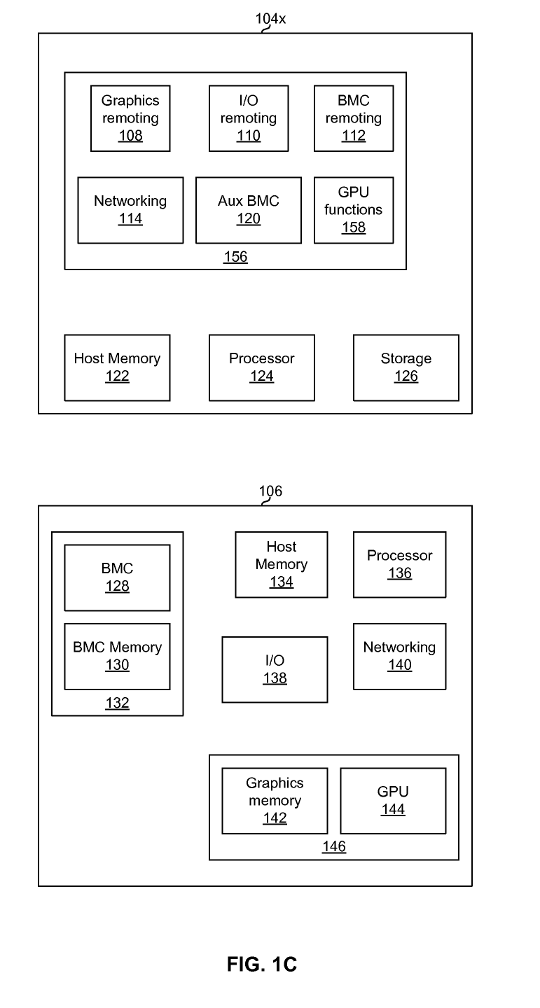

FIG. 1A is a diagram illustrating an exemplary centrally managed multi-unit networking system, in accordance with an embodiment of the invention. Referring to FIG. 1, there is shown a networking system 102, networking and/or computation units NCUs 104₁-104₁₅, and central management unit (CMU) 106.

The console 103 may comprise, for example, a display and user input devices such as a keyboard and mouse. The console 103 may be operable to interact with the CMU 106. The CMU 106 may function as an intermediary or proxy such that viewing output from one or more of the NCUs 104₁-104₁₅, troubleshooting, maintenance, configuration, updating, or otherwise interfacing with one or more of the NCUs 104₁-104₁₅ may be performed from the console 103. In this manner, each NCU 104_{X} may be managed and/or otherwise interacted with, e.g., as a user would interact with a personal computer, as if each NCU 104_{X} comprises additional hardware that is conventionally required in the absence of a CMU 106. In this regard, functions performed by the CMU 106 and/or the NCUs 104₁-104₁₅, in communicating information between the NCUs 104₁-104₁₅ and the console 103, may be transparent to the console 103.

The console 103 may be local to the system 102. That is, the console 103 may be collocated with and/or built into the system 102. The console 103 may be locally connected to the CMU 106 utilizing, for example, USB, IEEE 1394, VGA, HDMI, and/or some other management port or interface. Alternatively, the console 103 may be remote from the system 102. That is, the console 103 may be in another room, building, or location than the system 102 and may communicate with the system 102 over one or more networks. The console 103 may be connected to the CMU 106 via a network connection utilizing, for example, TCP/IP and/or other remote networking protocols, for example USB over network and/or XML/HTTP and/or other management protocols.

The multi-unit networking system 102 may comprise, for example, a blade enclosure that houses NCUs in the form of blades, or a rack that houses rack-mount units. In the exemplary embodiment of the invention depicted, the multi-unit networking system 102 may support up to fifteen NCUs 104_{X} and one CMU 106, however, the invention is not limited with regard to the number of units in the multi-unit networking system 102. Also, in another embodiment of the invention, multi-unit networking system 102 may comprise a dedicated slot or drawer (not shown) for a CMU 106.

The NCUs 104₁-104₁₅ may each comprise suitable logic, circuitry, interfaces, and/or code that may be operable to perform various computing and/or networking functions. In an exemplary embodiment of the invention, each NCU 104_{X}, where X is an integer between 1 and 15, may comprise a server or server functionality and may enable a client to read, write, and/or execute data on the NCU 104_{X}. In various embodiments of the invention, logic, circuitry, interfaces, and/or code for managing operation of one or more of the NCUs 104 may be substantially implemented on the CMU 106. Accordingly, each NCU 104_{X} may comprise only a minimal amount of logic, circuitry, interfaces, and/or code required to support one or more management, input/output, and/or graphics functions. For example, various logic, circuitry, interfaces, and/or code on each NCU 104_{X} may enable proxy functionality between: (1) hardware and/or an operating system of the NCU 104_{X}, and (2) the CMU 106.

The CMU 106 may comprise suitable logic, circuitry, interfaces, and/or code that may be operable to perform management functions for one or more NCUs 104_{X} in the multi-unit networking system 102. In various embodiments of the invention, the CMU 106 may be operable to interface to a console 103 and may be operable to interface with one or more of the NCUs 104_{X}. In some embodiments of the invention, the console 103 may be locally connected to the CMU 106 via, for example, USB, IEEE 1394, VGA, HDMI, and/or some other management port. In some embodiments of the invention, the console 103 may be connected to the CMU 106 via a network utilizing, for example, TCP/IP and/or other networking protocols.

The CMU 106 may be operable to receive information from one or more of the NCUs 104_{X}, process the information as is required or appropriate, and convey the information to the console 103. The information may comprise, for example, management data, human interface data, and/or graphics. The CMU 106 may also be operable to receive information from the console, process the information as is required or appropriate, and convey the information to one or more of the NCUs 104_{X}. Also, the CMU 106 may be operable to, in response to information received from one or more of the NCUs 104_{X}, make one or more decisions and send information to the one or more NCUs 104_{X} to configure and/or control operations of the one or more NCUs 104_{X}.

In an exemplary embodiment of the invention, the CMU 106 may be implemented on one blade in a blade enclosure 102. In this regard, the blade on which the CMU 106 is realized may comprise a dedicated blade; may comprise a blade similar to one or more other blades but with additional logic, circuitry, interfaces, and/or code implemented and/or populated on the blade; or may comprise a dedicated module that may reside, for example, in a dedicated slot or drawer. In another exemplary embodiment of the invention, for a rack with multiple NCUs 104, the CMU 106 may be a dedicated unit that may be integrated into a top-of-rack switch, and/or may be a dedicated unit in the rack that interfaces with the NCUs via a top-of-rack switch.

In various embodiments of the invention, one or more components and/or functions of the CMU 106, such as the BMC subsystem 132, may be instantiated more than once on the CMU 106 to provide fault tolerance or resilience.

In operation, data generated by one or more sensors on one or more NCUs 104_{X} may be communicated to the CMU 106. The sensor data may be communicated via, for example, a backplane and/or one or more patch cables of the multi-unit networking system 102. The backplane and/or patch cables may be dedicated for traffic between the NCUs 104_{X} and the CMU 106 or may be shared general networking traffic communicated to and/or from the NCUs 104_{X}. The CMU 106 may process the sensor data and present corresponding information via the console 103. Additionally or alternatively, the CMU 106 may process the sensor data and make one or more determinations for configuring and/or controlling operation of the one or more NCUs 104_{X}. Based on the one or more determinations, the CMU 106 may communicate configuration and/or control data back to one or more NCUs 104_{X}. The configuration and/or control data may be processed accordingly by the one or more NCUs 104_{X} and may be communicated to, for example, hardware and/or an operating system of the one or more NCUs 104_{X}.

Input data from the console 103 may be communicated to the CMU 106. The CMU 106 may process the input data and communicate corresponding data to one or more units 104_{X}. The corresponding data may be received in the one or more NCUs 104_{X}, processed as necessary or desired, and conveyed to hardware and/or an operating system of the one or NCUs 104_{X}. In this manner, a console may interact with the one or more units 104_{X} as if connected directly to the one or more units 104_{X}. That is, the presence of the CMU 106 may be transparent to the console 103, transparent to one or more applications running on one or more NCUs 104_{X}, and/or transparent an operating system, or portion thereof, of the units 104_{X}. In this regard, requests and/or data transmissions from the one or more NCUs 104_{X} and/or from the console 103 may be handled by the management unit 106 in real-time or near real-time. In this manner, operation of the one or more units 104_{X} may be monitored, configured, and/or controlled from the console 103.

Graphics information generated in one or more NCUs 104_{X}, may be processed in the one or more NCUs 104_{X} for communication to the CMU 106, and may be communicated to the CMU 106 via, for example, a backplane or patch cable of the multi-unit networking system 102. The graphics information may comprise, for example, text, still images, video, and/or primitives or macros utilized to generate corresponding text, still images, and/or video. In the CMU 106, the graphics may be further processed for communication to the console 103, and may be communicated to the console 103. Processing of the video in the CMU 106 may comprise, for example, buffering the graphics, decompressing the graphics, rendering the graphics, and outputting the graphics via, for example, a VGA or HDMI port. In some instances, the graphics unit of the CMU 106 may be operable to output graphics to multiple displays simultaneously. In this manner, multiple NCUs 104_{X} may be managed or interacted with simultaneously, or nearly simultaneously.

In this manner, aspects of the invention may enable dynamic communications between the NCUs 104_{X}, the CMU 106, and the console 103. That is, any of the NCUs 104_{X}, the CMU 106, and the console 103 may generate commands and/or requests, and any of the NCUs 104_{X}, the CMU 106, and the console 103 may generate responses and/or act based on the commands and/or requests. In this manner, communications between the NCUs 104_{X} and the CMU 106, communications between the CMU 106 and the console 103, and/or communications between the NCUs 104_{X} and the console 103—via the CMU 106—may be utilized to, for example, determine status of, generate alerts for, and/or perform updates of the NCUs 104X, the CMU 106, and/or the console 103. Furthermore, such communications may be handled by the CMU 106 such that communications with multiple one of the NCUs may occur simultaneously, and/or it appears to the NCUs 106 that they are communicating with dedicated hardware.

Thus, by centralizing management, human interfaces, and/or graphics functions on the CMU 106, various logic, circuitry, interfaces, and/or code that would typically be instantiated Xmax times per multi-unit system 1-2, may be instantiated fewer than Xmax times per multi-unit networking system 102, where Xmax corresponds to the number of NCUs 104_{X} in the multi-unit system 102. For example, the logic, circuitry, interfaces, and/or code may be instantiated only once to maximize cost and space savings, or may be implemented two or three times to provide redundancy and fault tolerance.

FIG. 1B is a diagram illustrating an exemplary NCU and corresponding CMU, in accordance with an embodiment of the invention. Referring to FIG. 1B, there is shown an exemplary NCU 104_{X} and an exemplary CMU 106. The NCU 104_{X} comprises an integrated circuit (IC) 116, local memory 118, auxiliary baseboard management controller (Aux BMC) 120, host memory 122, processor 124, graphics processing unit (GPU) 125, and storage 126.

The local memory 118 may comprise, for example, SRAM and/or DRAM. The local memory may be utilized to store data and/or instructions associated with functions performed by the IC 116.

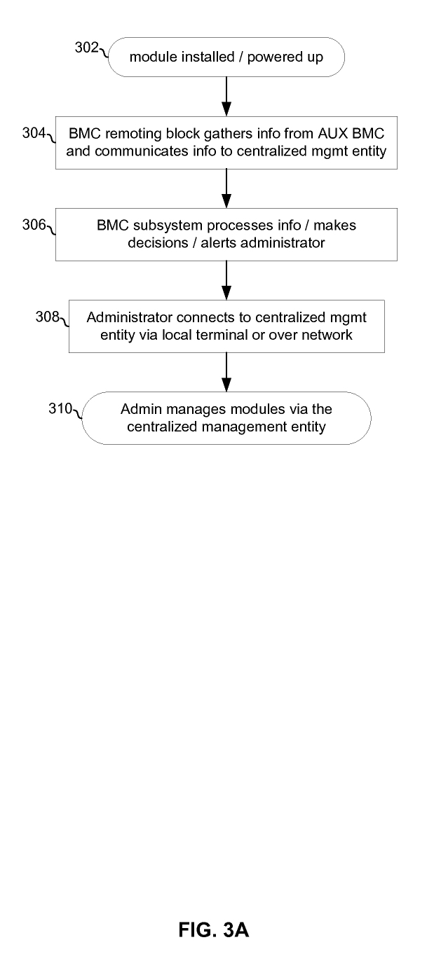

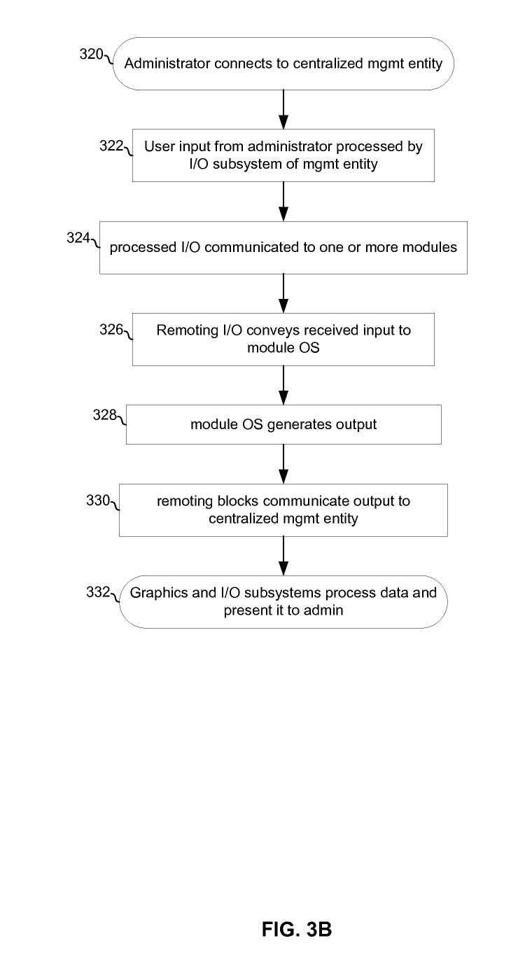

The auxiliary baseboard management controller (Aux BMC) 120 may comprise suitable logic, circuitry, interfaces, and/or code for monitoring various conditions on the NCU 104_{X}, and for controlling various functions and/or hardware components of the NCU 104_{X}. For example, the Aux BMC 120 may be used in order to interface with on-board sensors and/or analog devices such as fan and/or power supply unit. In this regard, the Aux BMC 120 may be operable to translate the signals generated by such sensors and/or devices into digital information that can be more easily transferred via, for example on the backplane of the multi-unit networking system 102. An exemplary Aux BMC 120 is described below with respect to FIG. 3A.

The processor 124 and the host memory 122 may comprise suitable logic, circuitry, interfaces and/or code that may enable processing of data and/or controlling of operations for the NCU 104_{X}. The host memory 122 may comprise, for example, SRAM and/or DRAM that stores data and/or instructions. The processor 124, utilizing the host memory 122, may be operable to run an operating system, perform networking functions, and/or otherwise manage operation of various functions performed by the NCU 104_{X}, In this regard, the processor 124, utilizing the host memory 122, may provide control signals to various components of the NCU 104_{X} and control data transfers between various components of the NCU 104_{X}.

The GPU 125 may comprise suitable logic, circuitry, interfaces, and/or code that may be operable to generate, render, compress, decompress, encrypt, decrypt, or otherwise manipulating graphics information. The GPU 125 may be enabled to output graphics to IC 116, and the graphics remoting block 108 may enable conveying the graphics to the CMU 106.

The storage 126 may comprise, for example, a hard drive or solid state memory. The storage 126 may store, for example, data that may be read, written, and/or executed locally or remotely utilizing the networking block 114.

The IC 116 may comprise suitable logic, circuitry, interfaces, and/or code that may enable communication with, and management of, the NCU 104_{X}. The IC 116 may comprise a graphics remoting block 108, an input/output (I/O) remoting block 110, baseboard management controller (BMC) remoting block 112, and general networking block 114, where each “block” represents suitable logic, circuitry, interfaces, and/or code.

The graphics remoting block 108 may comprise suitable logic, circuitry, interfaces, and/or code that may be operable to communicate text, still images, and/or video to the CMU 106. The text, still images, and/or video may comprise, for example information useful for managing operations of the NCU 104_{X}. The text, images, and/or video may be generated by, for example, the GPU 125, and may be generated based on, for example, sensor data from the Aux BMC 120, contents of the local memory 118, contents of the host memory 122, operation of one or more applications running on the NCU 104_{X}, and/or based on any other information that conveys a status or configuration of the NCU 104_{X}. For example, the graphics may comprise a text-based and/or graphical user interface such as is presented by, for example, a Windows or Linux based machine. In one exemplary embodiment of the invention, the graphics may be communicated to the CMU 106 as a bit stream. In another exemplary embodiment of the invention, a graphics bit stream may be converted to symbols and the symbols may be communicated to the CMU 106. The graphics remoting block 108 may also compress graphics before sending the graphics to the CMU 106.

The I/O remoting block 110 may comprise suitable logic, circuitry, interfaces, and/or code that may be operable to, for example, receive input from the CMU 106, process the input as necessary, and convey the input to a hardware component and/or to an operating system of the unit 104_{X}. Additionally, the I/O remoting block 110 may comprise, for example, receiving output from hardware and/or an operating system of the NCU 104_{X}, processing the output as necessary, and conveying the output to the CMU 106. The output may comprise, for example, audio notifications and/or other user feedback. The output may comprise, for example, reply traffic, such as ACKs or NACKs in response to user input. In this regard, the reply traffic may be defined by whatever protocols, such as universal serial bus (USB) or IEEE 1394 utilized for inputting the data. For example, the input may be an indication of a mouse movement and/or keystroke by a user of the console 103, and the reply traffic may comprise an updated graphics stream showing the mouse movement or the typed letter. In this manner, the I/O remoting block 110 may enable a human interface with the NCU 104_{X} via the CMU 106. Furthermore, the NCUₓ 104 may be presented with hardware and/or software signals that may be similar to or mimic instances where the I/O devices, such as a mouse and keyboard, are locally attached. In this regard, the software and/or operating system of the NCU 104 may be unable to distinguish between: input and/or output generated and/or processed locally, input and/or output generated and/or processed locally in combination with the logic and/or software on the CMU 106, and input or output generated and/or processed in combination with the logic and/or software on the console 103.

The baseboard management controller (BMC) remoting block 112 may comprise suitable logic, circuitry, interfaces, and/or code that may be operable to, for example, receive data generated by one or more sensors or other devices communicatively coupled to the BMC, process the sensor data as necessary, and communicate the data to the CMU 106. Additionally, BMC remoting block 112 may be operable to, for example, receive information from the CMU 106, process the data as necessary, make local determinations and/or decisions if applicable, and convey the data to hardware and/or an operating system of the NCU 104_{X}. In this regard, the information may cause configuration and/or control of the NCU 104_{X}. For example, the CMU 106 may determine that the NCU 104_{X} needs to be reset based on the sensor data, and the data from the CMU 106 may cause a reset. As another example, the CMU 106 may determine, based on the sensor data, that the NCU 104_{X} is too hot and may communicate information to the NCU 104_{X} that causes an increase in fan speed on the NCU 104_{X}.

The networking block 114 may comprise suitable logic, circuitry, interfaces, and/or code that may be operable to receive data to be transmitted from hardware components and/or operating system of the NCU 104_{X}, process to-be-transmitted data for communication over a network, transmit data over a network, receive data via a network, process data received from a network for conveyance to a hardware component and/or operating system of the unit 104_{X}, and convey the received, processed data to the hardware component and/or operating system.

The CMU 106 may comprise suitable logic, circuitry, interfaces, and/or code that may enable management of one or more NCUs 104_{X}. Accordingly, the CMU 106 may be operable to communicate with one or more NCUs 104_{X} and with a console 103. The CMU 106 may comprise a BMC subsystem 132, a host memory 134, a processor 136, an I/O subsystem 138, a networking subsystem 140, and a graphics subsystem 146.

The BMC subsystem 132 may comprise suitable logic, circuitry, interfaces, and/or code that may be operable to perform functions for managing configuration and/or operation of one or more NCUs 104_{X}. The BMC subsystem 132 may be operable to receive information from the one or more NCUs 104_{X}, receive information from the console 103, make management decisions based on information received, communicate information to the one or NCUs 104_{X}, and communicate information to the console 103.

The processor 136 and the host memory 134 may comprise suitable logic, circuitry, interfaces and/or code that may enable processing data and/or controlling operations of the CMU 106. The host memory 122 may comprise, for example, SRAM, DRAM, and/or non-volatile memory that stores data and/or instructions. The processor 136, utilizing the host memory 134, may be operable to run an operating system or other code, perform networking functions, and/or otherwise manage operation of various functions performed by the CMU 106, In this regard, the processor 136, utilizing the host memory 134, may provide control signals to various components of the CMU 106 and control data transfers between various components of the CMU 106.

The I/O subsystem 138 may comprise suitable logic, circuitry, interfaces, and/or code that may be operable to handle input data from the console 103 and output data from the one or more NCUs 104_{X}. For example, the I/O subsystem 138 may handle input from devices such as a keyboard and a mouse of the console 103. The I/O subsystem 138 may process the input and communicate it to one or more NCUs 104_{X}. Additionally, the one or more NCUs 104_{X} may generate output data in response to inputs from the console 103, and that output may be communicated to and handled by the I/O subsystem 138.

The networking subsystem 140 may comprise suitable logic, circuitry, interfaces, and/or code that may be operable to receive to-be-transmitted data from hardware components and/or an operating system of the CMU 106, process to-be-transmitted data for communication over a network, transmit data over a network, receive data via a network, process data received from a network for conveyance to a hardware component and/or operating system of the CMU 106, and convey the received, processed data to the hardware component and/or operating system. The networking subsystem 140 may be operable to communicate messages, such as Ethernet frames, over a backplane of the multi-unit networking system 102, over patch cables in the multi-unit networking system 102, and/or over network cables that connect to devices that are external to the multi-unit networking system 102. In this manner, information may be exchanged with a console 103 and/or with one or more NCUs 104_{X} utilizing one or more networking protocols. The networking subsystem 140 may support various networking protocols such as, for example, TCP/IP and Ethernet. In various embodiments of the invention, the console 103 may connect to the CMU 106 via the networking subsystem 140.

In an exemplary embodiment of the invention, the console 103 may use a complete protocol stack, e.g., WS-MAN, and thus, in a conventional system, each NCU 104_{X} may accordingly implement a complete protocol stack for communicating with the console 103. The result is that logic, circuitry, interfaces, and/or code for implementing the protocol stack is instantiated on each of the NCUs 104_{X} and one or more of those instantiations may thus be redundant. In accordance with various aspects of the invention, however, fewer instantiations of such logic, circuitry, interfaces, and/or code may be necessary. For example, rather than a BMC subsystem 132 being instantiated on each of the NCUs 104_{X}, aspects of the invention may enable providing substantially equivalent BMC functionality via a single BMC subsystem 132 instantiated on the CMU 106. In this regard, multiple NCUs 104_{X} may be handled via a single BMC subsystem 132 by utilizing a different network address for each NCU 104X. For example, a plurality of network addresses may be associated with the BMC subsystem 132 and when such messages are received by the networking subsystem 140, they may be communicated to the BMC subsystem 132 from the networking subsystem 140. The BMC subsystem 132 may process the received messages and/or generate corresponding message based on the address of the received message. In this regard, messages generated by the BMC subsystem 132 may be addressed based on the NCU 104_{X} for which the messages are destined, and the networking subsystem 140 may be operable to forward the messages to the appropriate one(s) of the NCUs 104_{X}.

The graphics subsystem 146 may comprise suitable logic, circuitry, interfaces, and/or code that may be operable to generate graphics, receive graphics from one or more NCUs 104_{X}, process received and/or generated graphics, and convey the graphics to the console 103. Processing of the video in the CMU 106 may comprise, for example, buffering the graphics, decompressing the graphics, rendering the graphics, and outputting the graphics via, for example, a VGA or HDMI port. The graphics may comprise, for example, text, still images, and/or video. The graphics may convey information utilized for managing operations of the one or more NCUs 104_{X}. For example, the graphics may communicate application data, a graphical user interface, configuration data, performance metrics, and/or sensor output from the one or more NCUs 104_{X} to a user of the console 103.

In operation, sensor data generated by the Aux BMC 120 may be conveyed to the IC 116. The BMC remoting block 112 may enable the IC 116 to process the sensory data and communicate the sensor data to the CMU 106. The sensor data may be, for example, embedded in a network message and communicated between the networking block 114 of the NCU 104_{X} and the networking subsystem 140 of the CMU 106. The data may be conveyed to the BMC subsystem 132 which may process the sensor data. The BMC subsystem 132 may make one or more determinations for configuring and/or controlling operation of the NCU 104_{X}. Based on the one or more determinations, the BMC subsystem 132 may communicate configuration and/or control data back to the IC 116. The configuration and/or control data may be processed by the BMC remoting block 122, and may be communicated to, for example, hardware and/or an operating system of the NCU 104_{X}. In some embodiments of the invention, information from the BMC remoting block 112 and/or from the BMC subsystem 132 may be presented to the console 103 via the graphics subsystem 146.

Input data from the console 103 may be communicated to the CMU 106 via the networking subsystem 140 and/or via the I/O subsystem 138. The input data may be processed by the I/O subsystem 138 and may be communicated to the NCU 104_{X} via a network message communicated between the networking subsystem 140 of the CMU 106 and the networking block 114 of the NCU 104_{X}. Upon reception of the message in the networking block 114, the input data may be processed by the I/O remoting block 110 and/or the IC 116. The I/O remoting block 110 may process the input data such that it may be conveyed to, for example, hardware and/or an operating system of the NCU 104_{X}. In this manner, the console 103 may interact with the NCU 104_{X} as if connected locally to the NCU 104_{X}. That is, the presence of the CMU 106 may be transparent to the console 103 and/or to an operating system of the NCU 104_{X}. In this manner, operation of the NCU 104_{X} may be monitored, configured, and/or controlled from the console 103. Input data from the console 103 and data generated in response to the input data may be human interface data.

Graphics—text, still images, and/or video, for example—may be generated by the GPU 125. The graphics may be communicated to the graphics subsystem 146 by the graphics remoting block 108. The graphics subsystem 146 may process the graphics for output to the console 103. In an exemplary embodiment of the invention, the graphics remoting block 108 may receive digital video out (DVO) stream from the GPU 125, buffer the DVO data, encode or otherwise processes the DVO data for communication to the CMU 106, and communicate the DVO data to the CMU 106. The graphics subsystem 146 may buffer, decode, render, or otherwise process the DVO data. In this manner, the DVO stream may be reconstructed or recovered and communicated to the console 103 via the I/O subsystem 138 and/or the networking subsystem 140.

In various embodiments of the invention, the management unit 106 may be operable to interface with multiple ICs 116 or 156 simultaneously or what appears to be simultaneously by utilizing some form of multiplexing or multiple-access. Accordingly, multiple NCUs 104_{X} may be managed simultaneously or nearly simultaneously.

FIG. 1C is a diagram illustrating an exemplary NCU and corresponding CMU, in accordance with an embodiment of the invention. FIG. 1C depicts exemplary variations and/or levels of integrations that may be present in an IC such as the ICs 116 and 156. The NCU 104_{X} depicted in FIG. 1C comprises an integrated circuit (IC) 156, host memory 122, processor 124, and storage 126. The IC 156 may comprise suitable logic, circuitry, interfaces, and/or code that may enable communication with, and management of, the NCU 104_{X}. The IC 156 may comprise a graphics remoting block 108, an input/output (I/O) remoting block 110, BMC remoting block 112, graphics processing block 158, Aux BMC block 120, and general networking block 114, where each “block” represents suitable logic, circuitry, interfaces, and/or code.

One difference between the IC 116 and the IC 156 is the integration of the Aux BMC 102. In this regard, integration of the Aux BMC 120 into the IC 156 may reduce size and/or cost of the NCU 104.

Another difference between the IC 116 and the IC 156 is that the IC 156 may share the host memory 122 as opposed to having dedicated local memory 118. In this regard, one or more portions of the host memory may be allocated for use by the IC 156. For example, code and/or data associated with BMC functions, I/O functions, and/or graphics functions may be stored in the memory 122. Furthermore, portions of the memory 122 may be dynamically allocated for use by the IC 156 as needed. In one exemplary embodiment of the invention, the IC 156 may comprise some integrated memory which may be utilized as a cache and/or for paging into the host memory. Similar partitioning and/or reallocation of memory may be possible for other blocks and/or functions in the IC 116 and/or the IC 156. In this regard, one or more portions of the host memory may be shared among a plurality of hardware components and/or application running on the NCU 104_{X}, but may be accessed such that it appears as dedicated memory to each of the hardware components and/or applications. For example, during start-up of the NCU 104_{X}, a BIOS of the NCU 104_{X} may detect a configuration of the NCU 104_{X} and may partition the memory 122 such that various portions of the memory 122 may be dedicated to, for example, supporting general operating system functions, supporting BMC functions, supporting graphics functions, and/or supporting networking functions. In this regard, it should be noted that just a couple examples of the various ways in which memory may be allocated and/or partitioned in an IC, such as the ICs 116 and 156, are depicted for illustration and the exemplary embodiments described herein are not exhaustive of the possible memory schemes.

Another difference between the IC 116 and the IC 156 is the integration of the GPU functions 158 in the IC 156. In one embodiment of the invention, integrated graphics functions 158 may, for example, comprise an API or graphics library that may emulate the GPU 125 of FIG. 1B. In this regard, the processor 124 and/or operating system of the NCU 104_{X} may interface with the graphics functions 158 via, for example, a PCI-e bus. In this manner, data and/or control signals may be conveyed to the graphics functions 158, the graphics functions 158 may generate a stream of graphics data in response, and the graphics stream may be communicated to the unit 106 via graphics remoting block 108. In another embodiment of the invention, the GPU functions 158 may appear as a graphics driver and/or operate at the register level. In this regard, the GPU functions 158 may be operable to emulate a specific graphics controller. For example, the processor 124 may attempt to access a register in what it believes to be the GPU 125, and the GPU functions 158 may trap the register accesses by the processor 124 or operating system. Similarly, the processor 124 and/or operating system may generate commands intended for the GPU 125 and the GPU functions 158 may perform real-time termination of the commands such that the processor 124 and/or operating system are unaware that the bulk of the graphics processing is occurring remotely in the graphics subsystem 146.

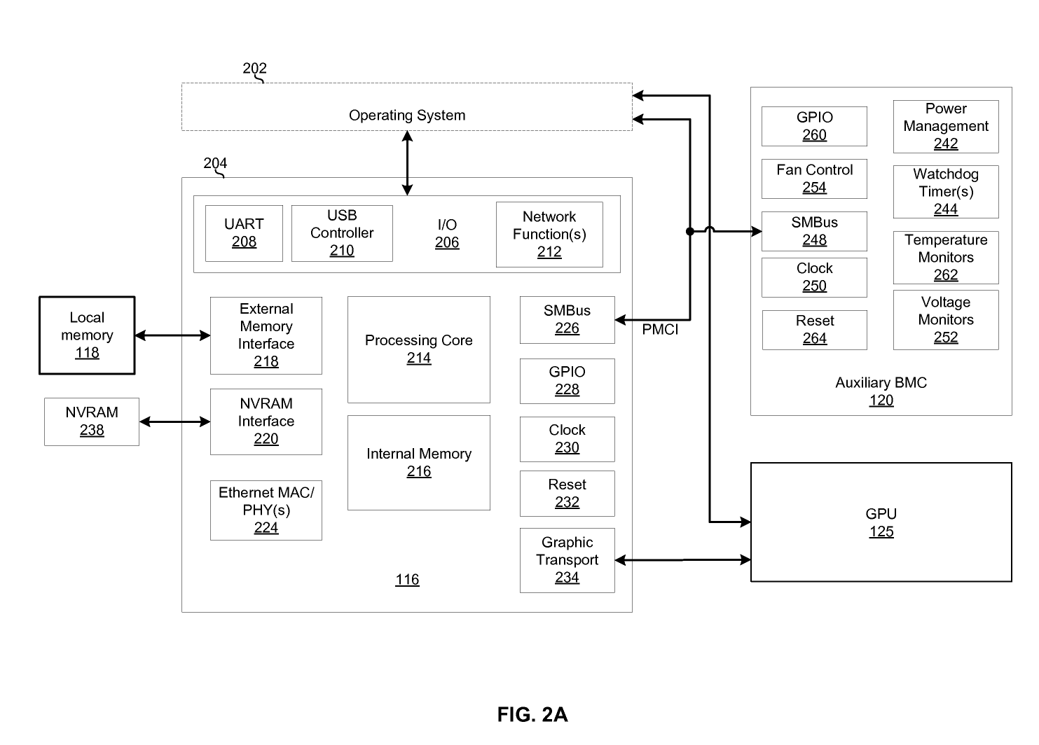

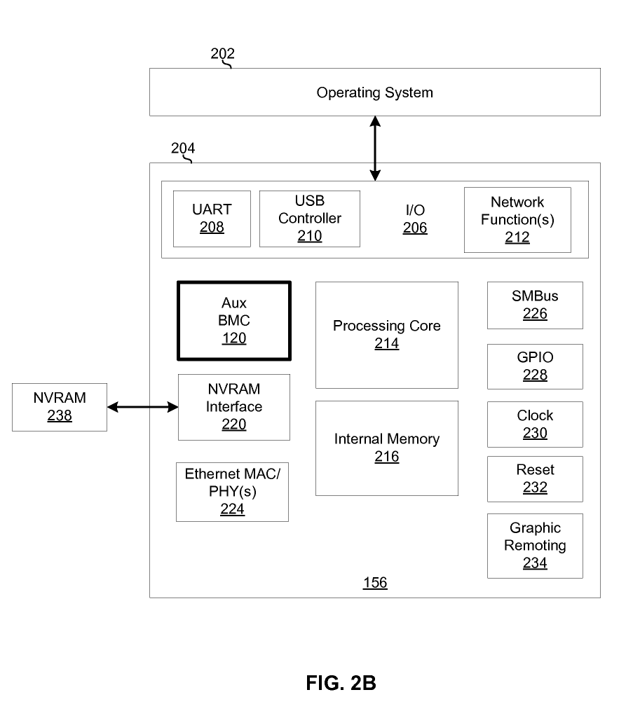

FIG. 2A is a diagram illustrating an exemplary chipset for centralized management of one or more NCUs, in accordance with an embodiment of the invention. Referring to FIG. 2A, there is shown an exemplary implementation of the IC 116 and the Aux BMC 120 described with respect to FIG. 1B. The IC 116 may comprise an IC 204 comprising an I/O block 206, an external memory interface 218, an nonvolatile RAM (NVRAM) interface 220, one or more Ethernet MACs and/or PHYs 234, a processing core 214, internal memory 316, an SMbus interface 326, a general purpose input/output (GPIO) interface 228, a clock 230, a reset block 232, and a graphic transport block 234.

The I/O block 206 may comprise suitable logic, circuitry, interfaces, and/or code that may be operable to perform, for example, I/O remoting functions. In this regard, the I/O block 206 may be operable to function as an interface between the OS 202 and a CMU 106.

The external memory interface 218 may comprise suitable logic, circuitry, interfaces, and/or code that may be operable to interface to local memory 118 which may comprise, for example, DRAM. The nonvolatile RAM (NVRAM) interface 220 may comprise suitable logic, circuitry, interfaces, and/or code that may be operable interface to an NVRAM 238. For example, the NVRAM may comprise boot code to initialize the IC 116.

The one or more Ethernet MACs and/or PHYs 234 may comprise suitable logic, circuitry, interfaces, and/or code that may enable communication over Ethernet links. In this regard, the IC 116 may support, for example, 10/100/1G/10 GBASE-T or any other Ethernet standard.

The processing core 214 and the internal memory 216 may comprise suitable logic, circuitry, interfaces, and/or code that may be operable to control operation of the IC 116. In this regard, the processing core 214 may, for example, control data transfers among blocks of the IC 116, schedule events in the IC 116, and perform processing necessary to support, for example, graphics, BMC, and/or I/O remoting.

The SMBus interface 226 may comprise suitable logic, circuitry, interfaces, and/or code that enables the IC 116 to communicate with other circuitry of the NCU 104_{X}. For example, data may be communicated between the processor 124 (FIG. 1B) and the Aux BMC 120 via the SMBus interface 226.

The general purpose input/output (GPIO) interface 228 may comprise suitable logic, circuitry, interfaces, and/or code that may be operable to support communications with various other components of the NCU 104_{X} and/or peripheral devices connected to the NCU 104_{X}.

The clock 230 may comprise suitable logic, circuitry, interfaces, and/or code that may be operable to generate a periodic signal which may be utilized for performing synchronous operations in the IC 116.

The reset block 232 may comprise suitable logic, circuitry, interfaces, and/or code that may enable resetting the IC 116. Resetting the IC 116 may, for example, initialize the various components of the IC 116 to a known state. In various embodiments of the invention, a signal received from the CMU 106 may trigger a reset of the IC 116.

The graphics transport block 234 may comprise suitable logic, circuitry, interfaces, and/or code that may enable interfacing to the GPU 125 and for remoting graphics information to the CMU 106. In various embodiments of the invention, the graphics transport block 234 may format, compress, or otherwise process graphic from the GPU 125 for communication to the CMU 106.

The Aux BMC 120 may comprise a power management block 242, a watchdog timer 344, a fan control block 254, an SMBus interface 248, a clock 250, voltage monitors 252, GPIO interface 260, temperature monitors 262, reset block 264, and reset 264.

FIG. 2B is a diagram illustrating an exemplary chipset for centralized management of one or more NCUs, in accordance with an embodiment of the invention. Referring to FIG. 2B there is shown an exemplary implementation of the IC 156. In FIG. 2B, the IC 256 comprises an I/O block 206, an Aux BMC block 120, an NVRAM interface 220, Ethernet MAC/PHY block 224, processing core 214, memory 216, SMBus interface 226, GPIO interface 228, clock generation block 230, reset block 232, and graphics remoting block 234. The I/O block 206 comprises, a universal asynchronous receiver and transmitter (UART) 208, a USB controller 210, and a networking block 212.

The IC 156 of FIG. 2B differs from the IC 116 of FIG. 2C in that the IC 156 has an integrated Aux BMC 106. Also, the IC 156 does not use a dedicated local memory, but shares host memory. The IC 116 in FIG. 2A and the IC 156 in FIG. 2B are by no means representative of all the possible variations of an IC that supports centralized management logic in a multi-unit networking system. Rather FIGS. 1B, 1C, 2A, and 2B illustrate just some of the possibilities and advantages in size, cost, and complexity that may be realized by centralizing management functions in a multi-unit networking system, rather than having redundant components on each NCU 104_{X} in a multi-unit networking system.

FIG. 3A is a flowchart illustrating exemplary steps for centralized management of one or more NCUs in a multi-unit networking system, in accordance with an embodiment of the invention. Referring to FIG. 2A, the exemplary steps may begin with step 302 when a NCU 104_{X} is installed or powered up in the multi-unit networking system 102. In step 304, the BMC remoting block 121 may gather sensor data from the Aux BMC 120 and communicate the sensor data to the CMU 106. In step 306, the BMC subsystem 132 may process the sensor data and make decisions regarding management of the NCU 104_{X}. Additionally, the BMC subsystem 132 may generate one or more messages that may be conveyed to the console 103. In step 308, a console 103 may connect to the CMU 106 via the console 103 which may be locally connected and/or connected over a network. In step 310, one or more NCUs 104_{X} may be selected, via the console 103, to monitor, configure, troubleshoot, or otherwise manage, and may mange the selected NCUs 104_{X} as if connected or connected directly to the NCUs 104_{X}. In this regard, the CMU 106 may handle a substantial amount of the processing of information but may be transparent to both the console 103 and the NCU 104_{X}. Interaction with the console 103 may be automated and/or performed by a network administrator.

FIG. 3B is a flowchart illustrating exemplary steps for centralized management of one or more NCUs, in accordance with an embodiment of the invention. Referring to FIG. 3B the exemplary steps may begin with step 320 in which a console 103 connects to the CMU 106. In step 322, data input to the console 103 may be processed by the I/O subsystems 138. The data may be input by, for example, a network administrator or an automated process. In step 324, the processed user input may be communicated to the unit 104_{X}. In step 326, the user input may be received and processed by the I/O remoting block 110. The I/O remoting block 110 may convey the user input to an operating system of the NCU 104_{X}. In step 328, the operating system of the NCU 104_{X} may generate output data, which may comprise graphics, in response to the user input. In step 330, the I/O remoting block 110 and/or the graphics remoting block 108 may process the output from the OS and may convey corresponding data to the CMU 106. In step 332 the networking subsystem 140 may convey the received data to the graphics subsystem 146 and/or the I/O subsystem 138. The graphics subsystem 146 may process the data for output graphics to the console 103, and the I/O subsystem 138 may process the data for output to the console 103.

It should be noted that FIGS. 1B, 1C, 2A, and 2B illustrate exemplary levels of integration that may be present in various embodiments of the invention. In this regard, the embodiments depicted in FIGS. 1B, 1C, 2A, and 2B are just examples for purposes of illustration and are not exhaustive. For example, additional and/or fewer functions may be integrated into either of the ICs 116 and 156, additional and/or fewer functions may be relocated from the NCUs 104 to the CMU 106, and/or memory in the NCUs 104 and/or the CMU 106 may be partitioned differently.

Aspects of a method and system for centralized logic for centrally managed machines. In an exemplary embodiment of the invention, a plurality of NCUs 104_{X} and a management unit 106 that manages operations of the plurality of NCUs 104_{X} may reside in a multi-unit system 102, and information may be communicated between the plurality of NCUs 104_{X} and the CMU 106 such that a console connected to the CMU may be enabled to interface with the plurality of NCUs 104_{X}. At least some hardware that performs management functions, human interface functions, and/or graphics functions may be implemented only once in the multi-unit system 102 and may be implemented on the CMU 106. The information may comprise one or more of: graphics, data from one or more input devices of the console 103, data to one or more output devices, data generated by one or more of the NCUs 104_{X} or by one or more of the sensors in the Aux BMC 120, and data that configures or controls operations of the NCU 104_{X}. Each of the plurality of NCUs 104_{X} and the CMU 106 may be, for example, a blade or a rack-mount unit. The information may be packetized and communicated over a backplane of the multi-unit system, over copper cabling, and/or over fiber optic cabling. The backplane, copper cabling, and/or fiber optic cabling may carry the information in addition to network traffic communicated between the multi-unit system and devices external to the multi-unit system.

The CMU 106 may be transparent to one or both of the console 103 and an operating system of each of the plurality of NCUs 104_{X}. The console 103 may be locally connected to the CMU 106 and/or may be connected to the CMU 106 via a network. The information may comprise graphics and the CMU 106 may render the graphics for display via the console 103. The CMU may be operable to output graphics to multiple displays simultaneously. User input may be received from the CMU 106 and communicated to an operating system 302 or hardware, such as the processor 124, of the NCU 104_{X}, wherein the user input may originate in a console 103 connected to the CMU 106. Data may be collected from one or more sensors in the Aux BMC 120 on the NCU 104_{X} and communicated to the CMU 106. In response to the collected data, the CMU 106 may generate information and communicate the generated information to the NCU 104_{X}.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for centralized logic for centrally managed machines.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for networking, the method comprising:
in a multi-unit system comprising a plurality of networking and/or computing units (NCUs) and a central management unit (CMU):
communicating information between said CMU and said plurality of NCUs such that a console connected to said CMU is enabled to interface with said plurality of NCUs, wherein at least some hardware that performs management functions, human interface functions, and/or graphics functions for said plurality of NCUs is implemented on said CMU.

2. The method according to claim 1, wherein said information comprises one or more of: graphics, human interface data, and/or data generated by one or more sensors.

3. The method according to claim 1, wherein each of said plurality of NCUs and said CMU is a blade or a rack-mountable unit.

4. The method according to claim 1, wherein said information is packetized and communicated over a backplane of said multi-unit system, over copper cabling, and/or over fiber optic cabling.

5. The method according to claim 4, wherein said backplane, said copper cabling, and/or said fiber optic cabling carries said information in addition to network traffic communicated between said multi-unit system and devices external to said multi-unit system.

6. The method according to claim 1, wherein said CMU is transparent to one or both of said console and an operating system of each of said plurality of NCUs.

7. The method according to 1, wherein said console is locally connected to said CMU.

8. The method according to 1, wherein said console is connected to said CMU over a network.

9. The method according to claim 1, wherein said information comprises graphics and said CMU renders said graphics for display via said console.

10. The method according to claim 9, wherein said CMU is operable to output graphics to multiple displays simultaneously.

11. The method according to claim 10, wherein graphics output to each of said multiple displays is associated with a different one of said plurality of NCUs.

12. The method according to claim 1, wherein:
user input from said CMU is received by one or more processors and/or circuits in said one or more of said plurality of NCUs; and
said user input is communicated to an operating system of said one or more of said plurality of NCUs and/or to hardware of said one or more of said plurality of NCUs, wherein said user input originated in said console.

13. The method according to claim 12, wherein one or more processors and/or circuits of each of said plurality of NCUs is operable to collect data from one or more sensors on said one or more of said plurality of NCUs and communicate said collected data to said CMU.

14. The method according to claim 13, wherein, in response to said collected data, said CMU generates one or more messages and communicates said generated one or more messages to said processors and/or circuits, and/or communicates said generated one or more messages to said console.

15. A system for networking, the system comprising:
a multi-unit networking system that comprises a plurality of networking and/or computing units (NCUs) and a central management unit (CMU), wherein:
at least some hardware that performs management functions, human interface functions, and/or graphics functions for said plurality of NCUs is implemented on said CMU; and
said one or more circuits and/or processors are operable to communicate information between said CMU and said plurality of NCUs such that a console connected to said CMU is enabled to utilize said information to interface with said plurality of NCUs.

16. The system according to claim 15, wherein said information comprises one or more of: graphics, human interface data, and/or data generated by one or more sensors.

17. The system according to claim 15, wherein each of said plurality of NCUs and said CMU is a blade or a rack-mountable unit.

18. The system according to claim 15, wherein said information is packetized and communicated over a backplane of said multi-unit system, over copper cabling, and/or over fiber optic cabling.

19. The system according to claim 18, wherein said backplane, said copper cabling, and/or said fiber optic cabling carries said information in addition to network traffic communicated between said multi-unit system and devices external to said multi-unit system.

20. The system according to claim 15, wherein said CMU is transparent to one or both of said console and an operating system of each of said plurality of NCUs.

21. The system according to 15, wherein said console is locally connected to said CMU.

22. The system according to 15, wherein said console is connected to said CMU over a network.

23. The system according to claim 15, wherein said information comprises graphics and said central management unit renders said graphics for display via said console.

24. The system according to claim 23, wherein said CMU is operable to output graphics to multiple displays simultaneously.

25. The system according to claim 24, wherein graphics output to each of said multiple displays is associated with a different one of said plurality of NCUs.

26. The system according to claim 15, wherein one or more processors and/or circuits of each of said plurality of NCUs is operable to receive user input from said CMU and communicate said user input to an operating system of said one or more of said plurality of NCUs and/or to hardware of said one or more of said plurality of NCUs, wherein said user input originated in said console.

27. The system according to claim 26, wherein one or more processors and/or circuits of each of said plurality of NCUs is operable to collect data from one or more sensors on said one or more of said plurality of NCUs and communicate said collected data to said CMU.

28. The system according to claim 27, wherein, in response to said collected data, said CMU generates one or more messages and communicates said generated one or more messages to said processors and/or circuits, and/or communicates said generated one or more messages to said console.
